(19) United States
(12) Patent Application Publication
(10) Pub. No.: US 2008/0097027 A1
(43) Pub. Date: Apr. 24, 2008

(54) VARNISH COMPOSITION FOR INSULATING ELECTRICAL MACHINERY

(75) Inventors: Shihai Zhang, Schenectady, NY (US); Patricia Chapman Irwin, Altamont, NY (US); Donald Lee Cousins, Lawrence Park, PA (US); Edward Norman Peters, Lenox, MA (US); Weijun Yin, Niskayuna, NY (US); Gerardo Rocha-Galicia, Salkirk, NY (US); Gary William Yeager, Rexford, NY (US)

Correspondence Address: MCNEES WALLACE & NURICK LLC, 100 PINE STREET, P.O. BOX 1166, HARRISBURG, PA, 17108-1166, US

(73) Assignee: General Electric Company, Schenectady, NY (US)

(21) Appl. No.: 11/551,747

(22) Filed: Oct. 23, 2006

(51) Int. Cl. C08L 69/00

(52) U.S. Cl. 524/611

(57) ABSTRACT

A varnish composition for producing an electrically insulative thermoset coating is provided. The varnish composition includes poly(phenylene ether) having at least one end group having aliphatic unsaturation and a reactive solvent. When cured, the poly(phenylene ether) and reactive solvent form an electrically insulative thermoset.

### FIELD OF THE INVENTION

The present invention is directed to varnish compositions for insulating electrical machinery and more particularly to poly(phenylene ether) based varnish compositions.

### BACKGROUND OF THE INVENTION

Although the stator windings of electrical inductive devices, such as motors, are wound with magnet wire having an enamel or other insulative coating thereon, it is often desirable to further coat the windings and seal them from the environment. When the motor is used in environments where the stator is exposed to moisture or abrasive materials, such as sand and dirt, it is often desirable to further protect the stator windings from the environment by means of an additional coating. For example, protection of the stator windings is desirable in blower motors utilized in the cooling systems for locomotive traction motors. Protection is also desirable in open motors utilized in driving pumps in oil field applications, which are exposed directly to blowing sand and dirt, as well as moisture.

Conventional varnish compositions, such as those used in certain locomotive traction motors, are so-called “solventless” varnishes based on unsaturated polyester (UPE). However, these varnish systems have a glass transition temperature (Tg) below 80° C. and poor thermal stability. As a result, their performance at motor operating temperatures, usually about 160° C., is unsatisfactory and may result in significant thermal degradation even after short operating times. In addition, this varnish is brittle and subject to cracking, particularly when subjected to vibrations accompanying locomotive operation. The UPE varnish also has a high moisture absorption rate and its ester bonds are hydrolysable, which may further contribute to unsatisfactory performance of the motor or require more frequent maintenance intervals than desired.

These and other drawbacks are found in current electrically insulating varnish compositions.

What is needed is a varnish composition that can better withstand higher temperature and a method for electrically insulating electrical devices with the varnish composition.

### SUMMARY OF THE INVENTION

According to an exemplary embodiment of the invention, a composition is disclosed. The composition comprises a functional poly(phenylene ether) having an intrinsic viscosity in the range of about 0.06 deciliters per gram to about 0.2 deciliters per gram, measured in chloroform at 25° C. and a reactive solvent. The composition, when cured, has a resistance to thermal cycling sufficient to pass a nut cracking test and has a thermal stability sufficient to exhibit weight loss of less than about 2% after aging for 100 hours at 215° C.

According to another exemplary embodiment of the invention a composition comprises a functional poly(phenylene ether) having an intrinsic viscosity in the range of about 0.06 deciliters per gram to about 0.2 deciliters per gram, measured in chloroform at 25° C. and a reactive solvent, wherein the composition, when cured, has a glass transition temperature higher than about 75° C. and an elongation to break greater than about 2%.

In one embodiment of the invention a composition for electrically insulating a motor comprises a bifunctional poly(phenylene ether) having an intrinsic viscosity in the range of about 0.06 deciliters per gram to about 0.2 deciliters per gram, measured in chloroform at 25° C. and a reactive solvent, wherein the composition, when cured, has a resistance to thermal cycling sufficient to pass a nut cracking test and has a thermal stability sufficient to exhibit weight loss of less than about 2% after aging for 100 hours at 215° C.

In another embodiment, a composition for electrically insulating a motor comprises a poly(phenylene ether) having the structural formula

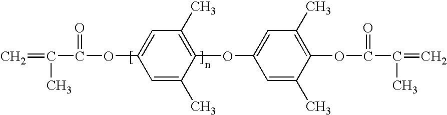

wherein n is any number sufficient to result in an intrinsic viscosity of about 0.09 deciliters per gram, measured in chloroform at 25° C. and a reactive solvent selected from the group consisting of vinyl toluene, styrene, t-butyl styrene, dibromostyrene and combinations thereof, wherein the weight ratio of poly(phenylene ether) to reactive solvent is the in the range of about 2:1 to about 1:5 and wherein the composition, when cured, has a resistance to thermal cycling sufficient to pass a nut cracking test and has a thermal stability sufficient to exhibit weight loss of less than about 2% after aging for 1200 hours at 225° C.

In another embodiment, a composition for electrically insulating a motor comprises a poly(phenylene ether) having the structural formula

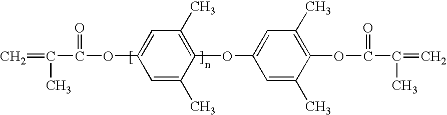

wherein n is any number sufficient to result in an intrinsic viscosity of about 0.06 deciliters per gram, measured in chloroform at 25° C. and a cross-linking agent selected from the group consisting of polybutadiene-methacrylate, trimethylolpropane triacrylate, ethoxylated bisphenol A, and combinations thereof and a reactive solvent selected from the group consisting of vinyl toluene, styrene, t-butyl styrene, dibromostyrene and combinations thereof, wherein the weight ratio of poly(phenylene ether) to cross-linking agent to reactive solvent is about 3:4:3 and wherein the composition, when cured, has a resistance to thermal cycling sufficient to pass a nut cracking test and has a thermal stability sufficient to exhibit weight loss of less than about 2% after aging for 100 hours at 215° C.

According to another embodiment of the invention, a composition for electrically insulating a motor comprises a monofunctional poly(phenylene ether) having a methacrlylate end group and an intrinsic viscosity of about 0.12 deciliters per gram, measured in chloroform at 25° C. a reactive solvent selected from the group consisting of vinyl toluene, styrene, t-butyl styrene, dibromostyrene and combinations thereof and a cross-linking agent selected from the group consisting of polybutadiene-methacrylate, trimethylolpropane triacrylate, ethoxylated bisphenol A, and combinations thereof, wherein the composition, when cured, has a resistance to thermal cycling sufficient to pass a nut cracking test and has a thermal stability sufficient to exhibit weight loss of less than about 2% after aging for 100 hours at 215° C.

According to another embodiment of the invention, a method for electrically insulating a motor using a varnish composition comprises providing a component of a motor, applying a varnish composition to the motor component, the varnish composition comprising a functional poly(phenylene ether) having an intrinsic viscosity in the range of about 0.06 deciliters per gram to about 0.2 deciliters per gram, measured in chloroform at 25° C. and a reactive solvent and curing the varnish composition to form an electrically insulative thermoset coating over the motor component, wherein the cured thermoset coating has a resistance to thermal cycling sufficient to pass a nut cracking test and has a thermal stability sufficient to exhibit weight loss of less than about 2% after aging for 100 hours at 215° C.

According to yet another embodiment of the invention, a motor comprises a traction motor winding coated with a thermoset resin, wherein the thermoset resin comprises poly(phenylene ether) with at least one aliphatic unsaturated end group having an intrinsic viscosity in the range of about 0.06 deciliters per gram and about 0.2 deciliters per gram, measured in chloroform at 25° C., crosslinked with a reactive solvent, wherein the thermoset resin has a resistance to thermal cycling sufficient to pass a nut cracking test and has a thermal stability sufficient to exhibit weight loss of less than about 2% after aging for 100 hours at 215° C.

The varnish is particularly useful as an electrically insulative coating for motors and generators, such as traction motors for locomotives and off-highway vehicles (OHV).

One advantage is that varnish compositions according to exemplary embodiments of the invention have a resistance to thermal cycling sufficient to pass a nut cracking test that a higher glass transition temperature and are more ductile, exhibiting a higher elongation to break than conventional varnish compositions.

Another advantage is that varnish compositions according to exemplary embodiments of the invention have a higher glass transition temperature and are more ductile, exhibiting a higher elongation to break than conventional varnish compositions.

Another advantage is that varnish compositions according to exemplary embodiments of the invention have reduced moisture uptake compared to conventional unsaturated polyester based varnish compositions.

Other features and advantages of the present invention will be apparent from the following more detailed description of exemplary embodiments, taken in conjunction with the accompanying drawings which illustrate, by way of example, the principles of the invention.

### BRIEF DESCRIPTION OF THE DRAWINGS

FIG. 1 is a graph illustrating moisture uptake with respect to time.

FIGS. 2a and b are graphs illustrating dielectric constant and dissipation factor each at 60 Hz as a function of temperature.

FIGS. 3a and b are graphs illustrating dielectric constant and dissipation factor each at 60 Hz as a function of temperature.

FIG. 4 is a graph illustrating thermal aging showing weight loss with respect to time.

FIG. 5 is a graph illustrating weight loss with respect to temperature.

FIG. 6 is a graph illustrating an Arrhenius plot for three different weight losses.

FIG. 7 is a graph illustrating lifetime hours with respect to temperature.

FIG. 8 is a graph illustrating thermal aging showing weight loss with respect to time.

FIG. 9 is a graph illustrating thermal aging showing weight loss with respect to time.

### DETAILED DESCRIPTION OF EXEMPLARY EMBODIMENTS

Exemplary embodiments of the invention are directed to electrically insulating varnish compositions comprising a poly(phenylene ether) (PPE) and a reactive solvent. The varnish composition is a “solventless” varnish. By solventless is meant that when combined, the varnish composition can be cured such that the PPE and the solvent react to form an electrically insulative thermoset.

The PPE employed in the present invention are known polymers comprising a plurality of structural units of the formula (I):

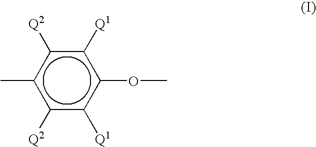

wherein each structural unit may be the same or different, and in each structural unit, each Q₁ is independently halogen, primary or secondary lower alkyl (i.e., alkyl containing up to 7 carbon atoms), phenyl, haloalkyl, aminoalkyl, hydrocarbonoxy, or halohydrocarbonoxy wherein at least two carbon atoms separate the halogen and oxygen atoms; and each Q₂ is independently hydrogen, halogen, primary or secondary lower alkyl, phenyl, haloalkyl, hydrocarbonoxy or halohydrocarbonoxy as defined for Q₁. It will be apparent to those skilled in the art from the foregoing that the PPE contemplated in the present invention include all those presently known, irrespective of variations in structural units or ancillary chemical features.

Both homopolymer and copolymer PPE are included. Also included are PPE containing moieties prepared by grafting vinyl monomers or polymers such as polystyrenes and elastomers, as well as coupled PPE in which coupling agents such as low molecular weight polycarbonates, quinones, heterocycles and formals undergo reaction in known manner with the hydroxy groups of two poly(phenylene ether) chains to produce a higher molecular weight polymer, provided a substantial proportion of free OH groups remains.

In a presently preferred embodiment of the invention, the PPE is a homopolymer in which Q1 is methyl and Q2 is hydrogen.

The PPE is terminated, or “capped”, on at least one end with an end group containing aliphatic unsaturation to create functional PPE. The PPE may be either mono or bi functional, i.e. the capping can be at only one end or at both ends of the PPE chain. The endcaps may be any aliphatic unsaturated functional group, typically acrylic, and preferably methacrylate.

Thus according to a current embodiment of interest, the PPE is a bi-functional methacrylate capped homopolymer having the formula (II) shown below:

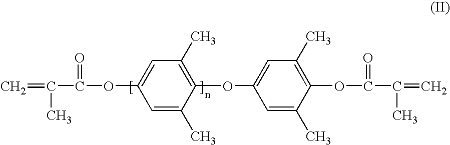

While the molecular weight and intrinsic viscosity of the PPE may vary, n is typically a number such that the intrinsic viscosity (“I.V.”) of the PPE is in the range of about 0.06 deciliters/gram to about 0.2 deciliters/gram and may be in the range of about 0.09 deciliters/gram to about 0.12 deciliters/gram as measured in chloroform at 25° C.

Functional PPE for use in accordance with exemplary embodiments of the invention may be made by any suitable method of making capped PPE, including but not limited to the method described in U.S. Pat. No. 6,897,282 which is hereby incorporated by reference in its entirety. Typically, this process begins with oxidative coupling of at least one monohydroxyaromatic compound such as 2,6-xylenol, 2,3,6-trimethylphenol by methods known in the art.

Catalyst systems are then generally employed for such coupling and they typically contain at least one heavy metal compound such as a copper, manganese, or cobalt compound, usually in combination with various other materials. The polymerization is performed in a suitable solvent such as benzene or toluene by way of example only, typically at a temperature about 20° C. to about 100° C. Thereafter, the catalyst is removed.

After removal of the catalyst, the PPE containing solution is concentrated to a higher solids level as part of the isolation of the PPE by removing the polymerization solvent. A suitable functionalizing agent, depending on the desired end group for the PPE, is added prior to and/or during the solvent removal, resulting in the capped PPE. For example, to make PPE having methacrylate end groups according to a preferred embodiment of the invention, a suitable functionalizing agent is methacrylic anhydride.

PPE is typically a solid at room temperature and forms one primary component of the varnish composition.

Another primary part of the varnish composition is a reactive solvent in which the PPE is dissolved prior to application of the varnish. By “reactive solvent” is meant any solvent that is curable with the PPE to form a thermoset. Exemplary solvents include vinyl toluene, styrene t-butyl styrene, dibromostyrene and combinations of those. Any suitable ratio of PPE to reactive solvent may be used, although the ratio is typically between about 2:1 to about 1:5 by weight of PPE:solvent, and may be about 1:1 by weight of PPE:solvent. However, these ratios may be further varied, for example, if any additives or cross-linking agents are added which may further enhance varnish performance.

Varnishes of compositions according to exemplary embodiments of the invention have been discovered by the inventors to form thermosets that have superior properties over those of conventional varnishes, including a significantly higher Tg, which generally is at least about 75° C. and may range up to about 170° C. or higher. More typically, the Tg is about 120° C. to about 165° C. As a result, the varnishes exhibit greater thermal stability over conventional varnishes, such as unsaturated polyester varnishes.

As described above, to form a varnish compositions according to an exemplary embodiment of the invention, the capped PPE is dissolved in the reactive solvent. The PPE is at least about 20% soluble in the reactive solvent at room temperature and may be at least about 40% soluble at room temperature.

The varnish composition is generally applied to a generator or motor winding, such as a traction motor winding for a locomotive or OHV, and cured. In an exemplary embodiment, the curing process results in a chemical reaction in which the solvent chemically reacts with the PPE and together forms a thermoset varnish coating that protects the entire motor winding assembly. The curing may be self-initiating or may require initiation of the reaction between the PPE and the reactive solvent through the use of a curing initiator, such as a catalyst.

The curing initiator may include any compound capable of producing free radicals at elevated temperatures. Such curing initiators may include both peroxy and non-peroxy based radical initiators. Examples of useful peroxy initiators include, for example, benzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, alpha,alpha′-bis(t-butylperoxy-m-isopropyl)benzene, 2,5-dimethyl-2,5-di(t-butylperoxy)hexane, di(t-butylperoxy)isophthalate, t-butylperoxy benzoate, 2,2-bis(t-butylperoxy)butane, 2,2-bis(t-butylperoxy)octane, 2,5-dimethyl-2,5-di(benzoylperoxy)hexane, di(trimethylsilyl)peroxide, trimethylsilylphenyltriphenylsilyl peroxide, and the like, and mixtures thereof. Suitable non-peroxy initiators include, for example, 2,3-dimethyl-2,3-diphenylbutane, 2,3-trimethylsilyloxy-2,3-diphenylbutane, and the like, and mixtures thereof. The curing initiator may further include any compound capable of initiating anionic polymerization of the unsaturated components. Such anionic polymerization initiators include, for example, alkali metal amides such as sodium amide (NaNH₂) and lithium diethyl amide (LiN(C₂H₅)₂), alkali metal and ammonium salts of C₁-C₁₀ alkoxides, alkali metal hydroxides, ammonium hydroxides, alkali metal cyanides, organometallic compounds such as the alkyl lithium compound n-butyl lithium, Grignard reagents such as phenyl magnesium bromide, and the like, and combinations thereof. In one embodiment, the curing initiator is a peroxide, such as 2,5-bis-(t-butyl peroxy)-2,5-dimethyl-3-hexane or dicumyl peroxide or combinations thereof. The curing initiator may promote curing at a temperature in a range of about 0° C. to about 200° C. When employed, the curing initiator is typically used in an amount of about 0.005 to about 2 parts by weight per 100 parts by weight total of PPE and reactive solvent.

There is no particular limitation on the method by which the composition may be cured. The composition may, for example, be cured thermally or by using irradiation techniques, including radio frequency heating, UV irradiation, and electron beam irradiation. For example, the composition may be cured by initiating chain-reaction curing with 10 seconds of radio frequency heating. When heat curing is used, the temperature selected may be about 80° to about 300° C., and the heating period may be about 5 seconds to about 24 hours. For example, if the curing initiator is dicumyl peroxide, the varnish may be cured for a time in the range of about 1 minute to about 10 hours at temperatures in the range of about 120° C. to about 200° C.

Curing may be conducted in multiple steps using different times and temperatures for each step. For example, curing may be staged to produce a partially cured and often tack-free resin, which then is fully cured by heating for longer periods or at higher temperatures. One skilled in the thermoset arts is capable of determining suitable curing conditions without undue experimentation. In some embodiments, the composition may be partially cured. However, references herein to properties of the “cured composition” or the “composition after curing” generally refer to compositions that are substantially fully cured. One skilled in the thermoplastic arts may determine whether a sample is substantially fully cured without undue experimentation. For example, one may analyze the sample by differential scanning calorimetry to look for an exotherm indicative of additional curing occurring during the analysis. A sample that is substantially fully cured will exhibit little or no exotherm in such an analysis.

The varnish can be applied and cured according to any suitable technique. One example of such a method is the vacuum pressure impregnation method, in which an entire motor winding assembly is placed in a pressure vessel under a high vacuum that draws out entrapped air and other gases. The varnish is introduced to the pressure vessel and the entire tank is pressurized, typically to at least 90 psi or higher to achieve a total penetration of the winding. The assembly may be baked at elevated temperatures to cure the varnish composition, i.e. to cause the PPE, the reactive solvent and any additives to form a thermoset, producing a solid, sealed insulation system substantially impervious to moisture. Other suitable coating and curing techniques include dip coat and trickle treat, by way of example only.

Although compositions according to exemplary embodiments of the invention provide excellent properties, particularly when compared to current unsaturated polyester varnishes, it may still be desirable to introduce additives to the varnish composition prior to curing to even further enhance various properties. For example, a cross-linking agent may be added to even further enhance ductility and thermal stability, particularly in embodiments in which the PPE is monofunctional. A cross-linking agent is defined as a compound comprising at least two polymerizable groups selected from carbon-carbon double bonds, carbon-carbon triple bonds, and combinations thereof. Preferably, the cross-linking agent has functional groups that are same as the PPE end caps. For example, where the end caps are methacrylate groups, particularly suitable cross-linking agents include methacrylate-grafted polybutadiene, trimethylolpropane triacrylate (TMPTA), ethoxylated bisphenol A dimethacrylate, and combinations thereof.

Other suitable cross-linking agents include, for example, divinylbenzenes, diallylbenzenes, trivinylbenzenes, triallylbenzenes, divinyl phthalates, diallyl phthalates, triallyl mesate, triallyl mesitate, triallyl cyanurate, triallyl isocyanurate, trimethylolpropane tri(meth)acrylate, 1,6-hexanediol di(meth)acrylate, neopentyl glycol di(meth)acrylate, dipropylene glycol di(meth)acrylate, ethylene glycol di(meth)acrylate, propylene glycol di(meth)acrylate, cyclohexanedimethanol di(meth)acrylate, butanediol di(meth)acrylate, diethylene glycol di(meth)acrylate, triethylene glycol di(meth)acrylate, isobornyl(meth)acrylate, methyl(meth)acrylate, methacryloxypropyl trimethoxysilane, bisphenol A dimethacrylate, (ethoxylated)₁₋₂₀ nonylphenol (meth)acrylates, (propoxylated)₁₋₂₀ nonylphenol (meth)acrylates, (ethoxylated)₁₋₂₀ tetrahydrofurfuryl(meth)acrylates, (propoxylated)₁₋₂₀ tetrahydrofurfuryl(meth)acrylates, (ethoxylated)₁₋₂₀ hydroxyethyl(meth)acrylates, (propoxylated)₁₋₂₀ hydroxyethyl(meth)acrylates, (ethoxylated)₂₋₄₀ 1,6-hexanediol di(meth)acrylates, (propoxylated)₂₋₄₀ 1,6-hexanediol di(meth)acrylates, (ethoxylated)₂₋₄₀ 1,4-butanediol di(meth)acrylates, (propoxylated)₂₋₄₀ 1,4-butanediol di(meth)acrylates, (ethoxylated)₂₋₄₀ 1,3-butanediol di(meth)acrylates, (propoxylated)₂₋₄₀ 1,3-butanediol di(meth)acrylates, (ethoxylated)₂₋₄₀ ethylene glycol di(meth)acrylates, (propoxylated)₂₋₄₀ ethylene glycol di(meth)acrylates, (ethoxylated)₂₋₄₀ propylene glycol di(meth)acrylates, (propoxylated)₂₋₄₀ propylene glycol di(meth)acrylates, (ethoxylated)₂₋₄₀ 1,4-cyclohexanedimethanol di(meth)acrylates, (propoxylated)₂₋₄₀ 1,4-cyclohexanedimethanol di(meth)acrylates, (ethoxylated)₂₋₄₀ bisphenol-A di(meth)acrylates, (propoxylated)₂₋₄₀ bisphenol-A di(meth)acrylates, (ethoxylated)₃₋₆₀ glycerol tri(meth)acrylates, (propoxylated)₃₋₆₀ glycerol tri(meth)acrylates, (ethoxylated)₃₋₆₀ trimethylolpropane tri(meth)acrylates, (propoxylated)₃₋₆₀ trimethylolpropane tri(meth)acrylates, (ethoxylated)₃₋₆₀ isocyanurate tri(meth)acrylates, (propoxylated)₃₋₆₀ isocyanurate tri(meth)acrylates, (ethoxylated)₄₋₈₀ pentaerythritol tetra(meth)acrylates, (propoxylated)₄₋₈₀ pentaerythritol tetra(meth)acrylates, (ethoxylated)₆₋₁₂₀ dipentaerythritol tetra(meth)acrylates, (propoxylated)₆₋₁₂₀ dipentaerythritol tetra(meth)acrylates, and the like, and mixtures thereof.

When present, the cross-linking agent may be used in an amount of about 1 to about 50 parts by weight, based on 100 parts by weight total of the PPE and the reactive solvent. Within this range, the crosslinker amount may be up to about 40 parts by weight, or up to about 30 parts by weight.

While current UPE varnish compositions generally have relatively low ductility, with an elongation to break of about 1% or less, exemplary embodiments of the invention generally have high ductility and may have an elongation to break greater than about 2%, and may be greater than about 2.5%, and may even be greater than about 3%.

Exemplary embodiments of the invention also have the advantage of excellent resistance to thermal cycling. Resistance to thermal cycling may conveniently be measured by a nut cracking test. In the nut cracking test, a half inch hex nut is placed in the center of an aluminum pan having a diameter of 2 inches. A sample is made by pouring 12 grams of varnish composition onto the nut in the aluminum pan and then degassing under vacuum for approximately 15 minutes. The sample is then cured. After curing and initial inspection, the sample is placed into an ice water bath (0° C.) for 30 minutes. After 30 minutes, the sample is removed, inspected for cracking, and placed immediately into a 180° C. oven for 30 minutes. It is then removed, inspected and returned immediately into the ice water. This cycle is repeated 5 times at these temperatures. If the sample passes these cycles without cracking, it generally indicates that the composition has sufficient ductility and resistance to thermal cycling for varnish applications. Compositions that crack during the cycles fail the test and are generally not suitable for varnish applications.

Other additives may include curing inhibitors and/or stabilizers that may increase shelf life of the varnish compositions.

Suitable curing inhibitors include, for example, diazoaminobenzene, phenylacetylene, sym-trinitrobenzene, p-benzoquinone, acetaldehyde, aniline condensates, N,N′-dibutyl-o-phenylenediamine, N-butyl-p-aminophenol, 2,4,6-triphenylphenoxyl, pyrogallol, catechol, hydroquinone, monoalkylhydroquinones, p-methoxyphenol, t-butylhydroquinone, C₁-C₆-alkyl-substituted catechols (such as 4 tert-butylcatechol), dialkylhydroquinone, 2,4,6-dichloronitrophenol, halogen-ortho-nitrophenols, alkoxyhydroquinones, mono- and di- and polysulfides of phenols and catechols, thiols, oximes and hydrazones of quinone, phenothiazine, dialkylhydroxylamines, and the like, and combinations thereof. Suitable curing inhibitors further include poly(arylene ether)s having free hydroxyl groups. When present, the curing inhibitor amount may be about 0.001 to about 10 parts by weight per 100 parts by weight total of PPE and reactive solvent. If added, the curing inhibitors may be in combination with or in lieu of curing initiators.

The composition may, optionally, further comprise one or more additives such as, for example, dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof.

The following examples are presentation by way of illustration only and not by way of limitation.

### EXAMPLES

### Example 1

The method described in U.S. Pat. No. 6,897,282 was used to make the methacrylate capped PPE compound illustrated in Formula II having an intrinsic viscosity of 0.09 dl/g. The PPE was then added to form a varnish composition of 50% by weight PPE and 50% by weight vinyltoluene. Dicumyl peroxide was then added at a concentration of 1% by weight and 500 ppm t-butyl catechol was introduced as a stabilizer. Samples of the varnish were then cured to form a thermoset. Curing was performed by holding the varnish in a convection oven for 2 hours at 160° C.

### Comparative Example 1

A conventional varnish composition of 50% by weight unsaturated polyester (UPE) and 50% by weight vinyltoluene, commercially available as 707C from Von Roll, Schenectady, N.Y., was obtained and cured for 2 hours at 160° C.

Properties of the two resulting thermosets were then measured and results are summarized in Table 1.

TABLE I

| Property | Example 1 | Comparative Example 1 |
|---|---|---|
| Tg (° C.) | 161 | 78 |
| Elongation to Break (%) | 3.0 | 0.8 |
| Ductility | 115 | 68 |
| (Unnotched Izod in J/M) | | |
| Dielectric Constant | 2.47 | 2.99 |
| (Dk @ 500 MHz) | | |
| Dissipation Factor | 0.001 | 0.031 |
| (Df @ 100 MHz) | | |

As illustrated by Table I, the PPE varnish has significantly higher Tg (161° C.) as compared with the UPE varnish (78° C.). The PPE varnish is also much more ductile than the UPE. The elongation to break of cured PPE is 3.0%, whereas it is only 0.8% for cured UPE. The unnotched Izod ductility of cured PPE is 115 J/M, and it is only 68 J/m for cured UPE. These results support that PPE varnish has superior performance as a varnish over UPE.

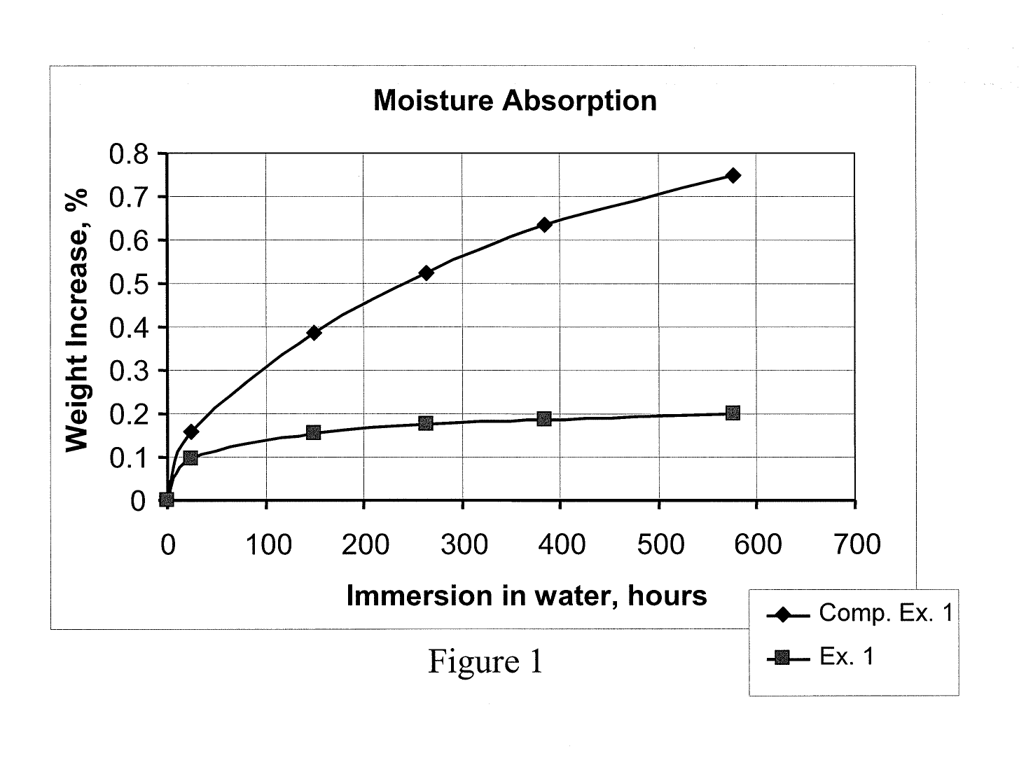

Moisture uptake of each of Example 1 and Comparative Example 1 were measured by soaking 2.5 in×0.5 in×0.125 in (63.5 mm×12.7 mm×3.18 mm) samples in water for 580 hours and measuring weight increase at various time intervals. Results are shown in FIG. 1. The PPE varnish of Example 1 absorbs only 0.2% water for 580 hours, consistent with its nonpolar chemical structure. The UPE varnish of Comparative Example 1 shows a much higher water absorption (0.75%) for the same period of soaking. Since many electrical components are operated in open air and can suffer from rain, snow, and other severe weather conditions, the low water uptake of Example 1 is advantageous.

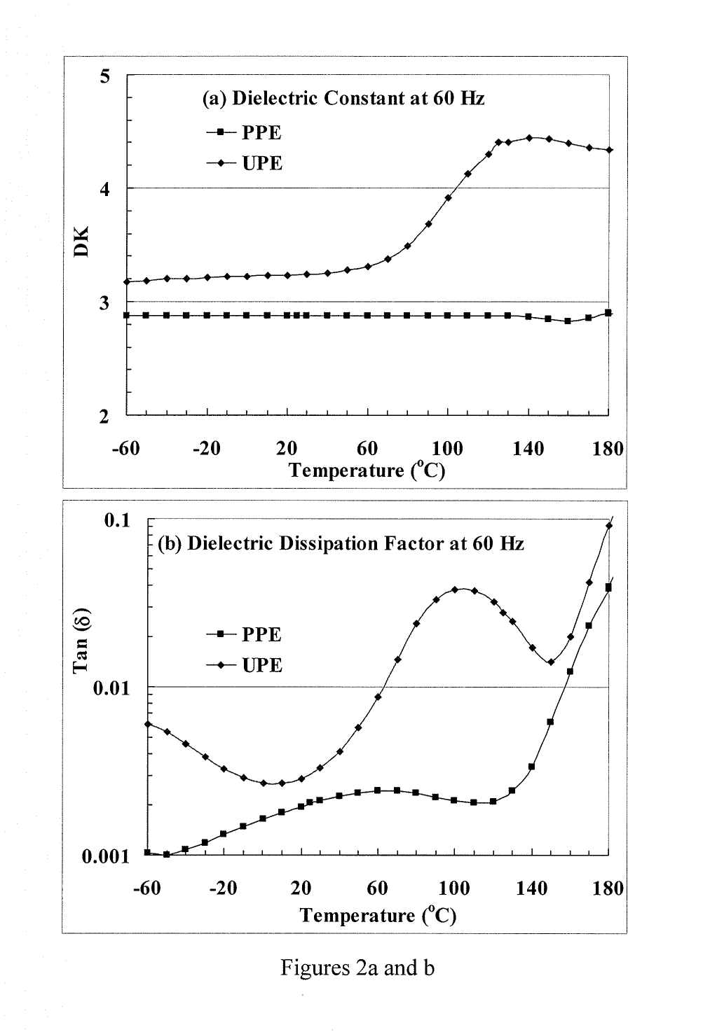

Dielectric constant (DK) and dielectric dissipation factor (tan δ) were measured at different temperatures and frequencies with a Novocontrol Dielectric Spectrometer available from Novocontrol of Hundsagen, Germany. FIGS. 2a and b show results for Example 1 and Comparative Example 1. The cured PPE varnish has a relatively constant DK of 2.9 across the range of −60 to 180° C. On the other hand, the cured UPE varnish of Comparative Example 1 has a DK of 3.2 below about 60° C., and increases to 4.4 at higher temperature. Low DK is desired for electrical insulation applications to minimize the capacitance and RC constant, so the low DK of Example 1 is an advantage over UPE for electrical insulation, particularly at temperatures above 100° C.

In addition, the dissipation factor of cured PPE is significantly lower than that of cured UPE varnish below 160° C. High dielectric dissipation factor generally leads to high heat generation and can lead to insulation failure even at low temperatures. Therefore, the dielectric properties of cured PPE varnish are much more desirable than these of cured UPE varnish.

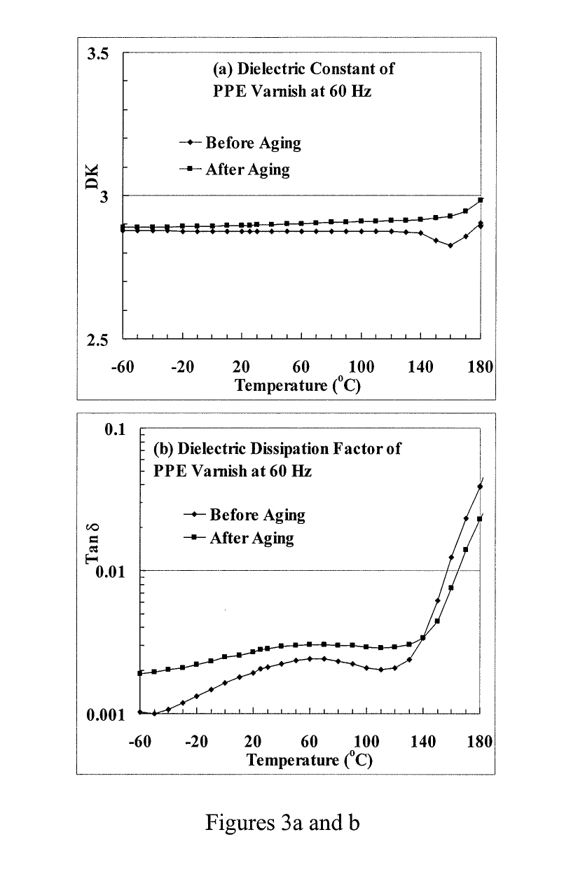

DK and tan δ were also measured after further aging the cured PPE varnish sample at 225° C. for 96 hours; results are shown in FIGS. 3a and b. DK of aged PPE does not change much as compared to a fresh sample. Tan δ exhibits a slight increase below 140° C., but it is still much lower than UPE varnish. The figures confirm that thermal aging does not significantly influence the dielectric constant and dissipation factor, which is desirable for electrical insulation for high temperature applications.

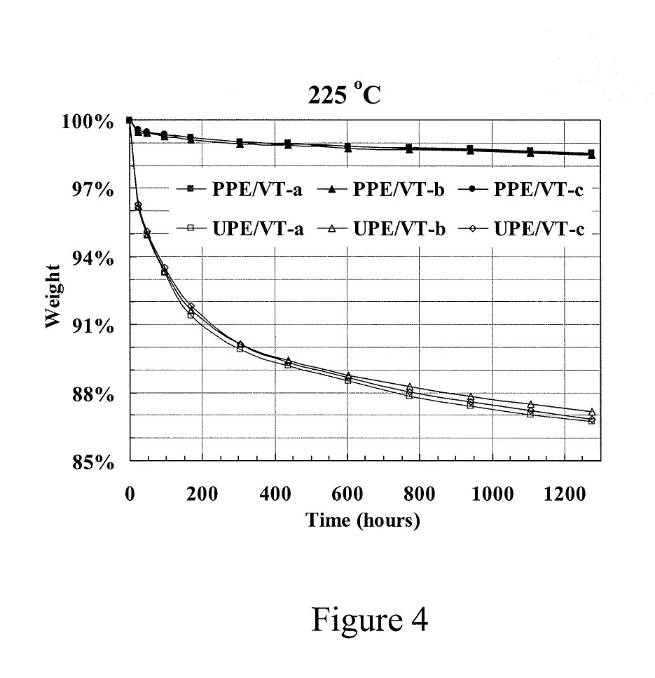

Thermal aging tests of multiple samples of Example 1 and Comparative Example 1 were conducted by aging in a convection oven at a constant temperature of 225° C. The weight loss of the composition was measured at different times, the results of which are shown in FIG. 4 (in which the three trials for Example 1 are designated PPE a-c and Comparative Example 1 are designated as UPE a-c), which shows a loss of less than about 2% by weight of the composition of Example 1 after about 100 hours of aging at 225° C. and were still less than about 2% even after 1200 hours at that temperature. While not wishing to be bound by theory, additional thermal cross-linking may occur during aging in the cured PPE varnish and it does not degrade at high temperature. This high thermal stability with low degradation is desirable for many electrical components that are operated at temperatures above 180° C. with hot spots above 220° C. Varnishes with low thermal stability and high weight loss cannot be used for such electrical components with expected service time of 20 years. For comparison, the cured UPLE samples degrade so quickly that they lost 5% weight in only 48 hours at 225° C.

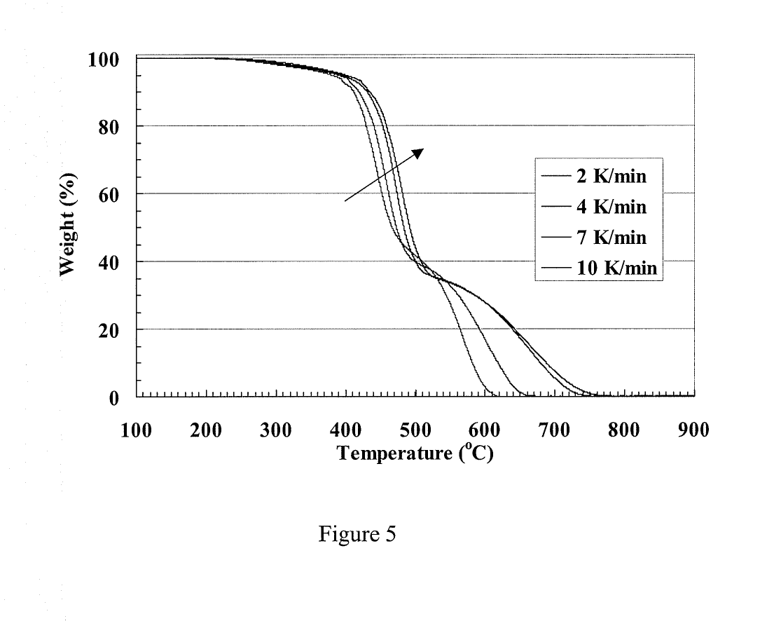

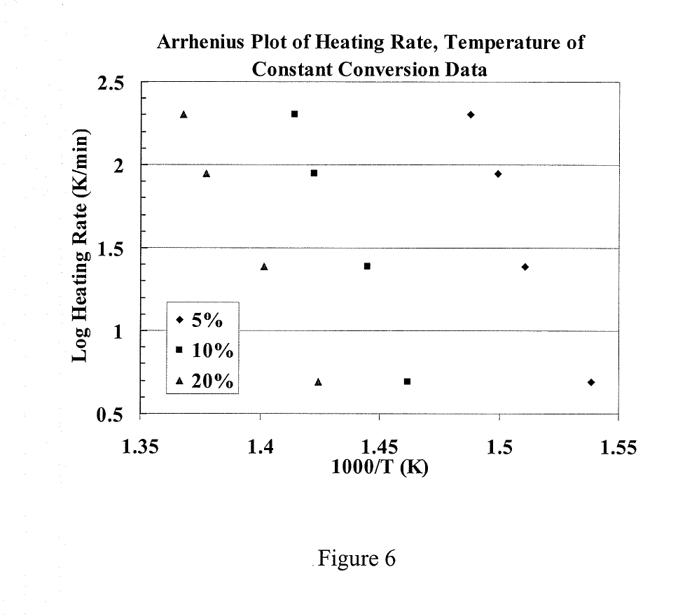

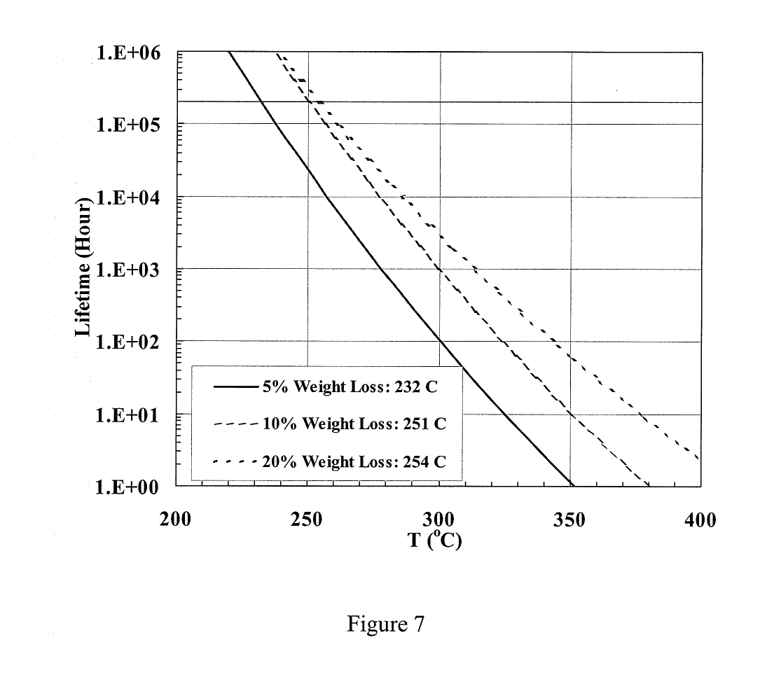

The relative thermal index (RTI) of Example 1 was evaluated following ASTM E 1877: “Standard Practice for Calculating Thermal Endurance of Materials from Thermogravimetric Decomposition Data.” Air purge at 40 ml/min and heating rates of 2, 4, 7, and 10 K/min were used for the thermogravimetric analysis (TGA). FIG. 5 provides the TGA traces of PPE varnish at different heating rate and Table II lists the temperatures at which the weight loss is 5%, 10% and 20%. The activation energy was calculated in FIG. 6 following ASTM E 1877 and given in Table 11. Then the RTI was estimated from FIG. 7 with the activation energies in Table 11. The RTI was defined for an expected lifetime of 200,000 hours for the composition of Example 1.

TABLE II

| Heating rate (K/min) | T (5%, ° C.) | T (10%, ° C.) | T (20%, ° C.) |
|---|---|---|---|
| 10 | 399 | 434 | 458 |
| 7 | 394 | 430 | 453 |
| 4 | 389 | 419 | 440.4 |
| 2 | 377 | 411 | 429 |
| Activation Energy | 267395 | 268085 | 229200 |
| (J/mol) | | | |
| a* | 24.226 | 23.3212 | 19.2276 |
| RTI (° C.) | 232 | 251 | 254 |

*as obtained according to ASTM E 1877

Consistent with the low weight loss at 225° C. thermal aging, the cured PPE varnish of Example 1 has an RTI above 230° C. based on the TGA results. This is advantageous in light of the 180° C. operating temperature of many electrical components.

Three samples of each of the compositions of Example 1 and Comparative Example 1 were subjected to the nut cracking test. All samples of Example 1 and Comparative Example 1 passed the nut cracking test. This further demonstrates that the Example 1 has good ductility and is consistent with its high elongation to break and Izod test result in Table 1. Although Comparative Example 1 also passed the nut cracking test, its low thermal stability, high moisture uptake, high DK, and high tan δ are not desirable for electrical insulation applications.

### Example 2

The method described in U.S. Pat. No. 6,897,282 was used to make the methacrylate capped PPE compound illustrated in Formula II having an intrinsic viscosity of 0.06 dl/g. The PPE along with a methacrylate-grafted polybutadiene crosslinking agent was then added to vinyltoluene in equal percents by weight, along with 1% dicumyl peroxide to form a varnish composition. Samples of the varnish were then cured to form a thermoset at 160° C. for 2 hours and an additional hour at 180° C.

### Comparative Example 2

A sample composition was formed in the same manner as that of Example 2, except that the cross-linking agent was omitted with PPE and vinyltoluene only added in equal parts.

Although both the compositions of both Example 2 and Comparative Example 2 exhibited acceptable thermal stability when subjected to thermal aging tests, only the composition of Example 2 showed sufficient resistance to thermal cycling to pass the nut cracking test.

### Example 3

The method described in U.S. Pat. No. 6,897,282 was used to make mono functional methacrylate capped PPE having an intrinsic viscosity of 0.12 dl/g. The PPE was then added to styrene along with SR348 (an ethoxylated bisphenol A dimethacrylate commercially available from Sartomer of Exton, Pa.) as a cross linking agent in a weight ratio of 3:4:3 of PPE/styrene/SR348.2% by weight of 2,5-bis-(t-butyl peroxy)-2,5-dimethyl-3-hexane (commercially available as Trigonox 101 from Akzo Nobel Polymer Chemicals of Chicago, Ill.) was added as the curing initiator. The varnish was degassed under vacuum and then cured to a thermoset at 110° C. for 2 hours then at 150° C. for 30 minutes in a preheated convection oven. This composition also passed the nut cracking test.

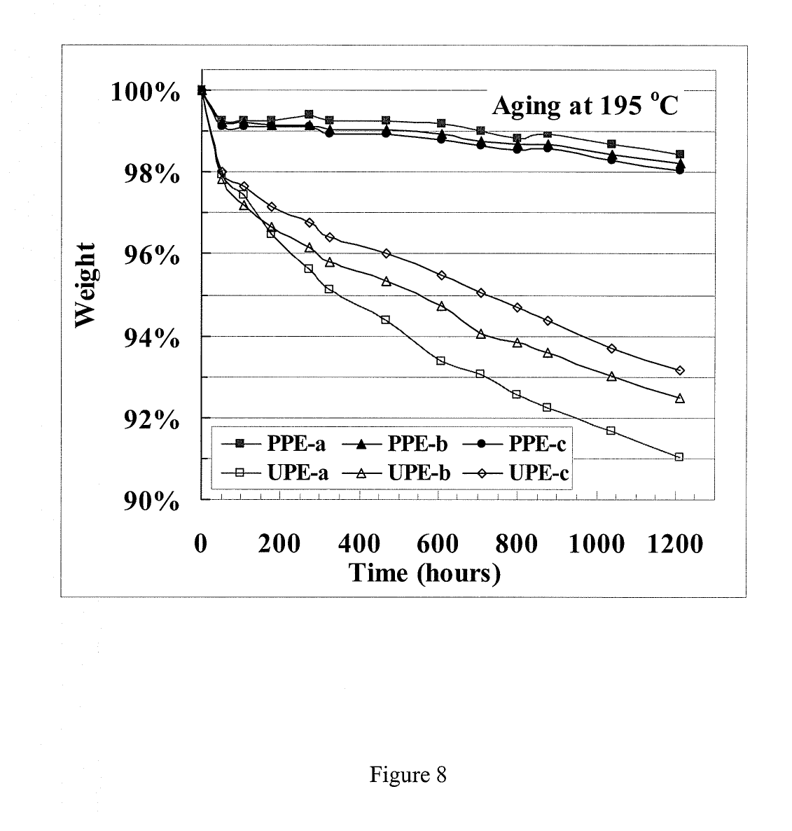

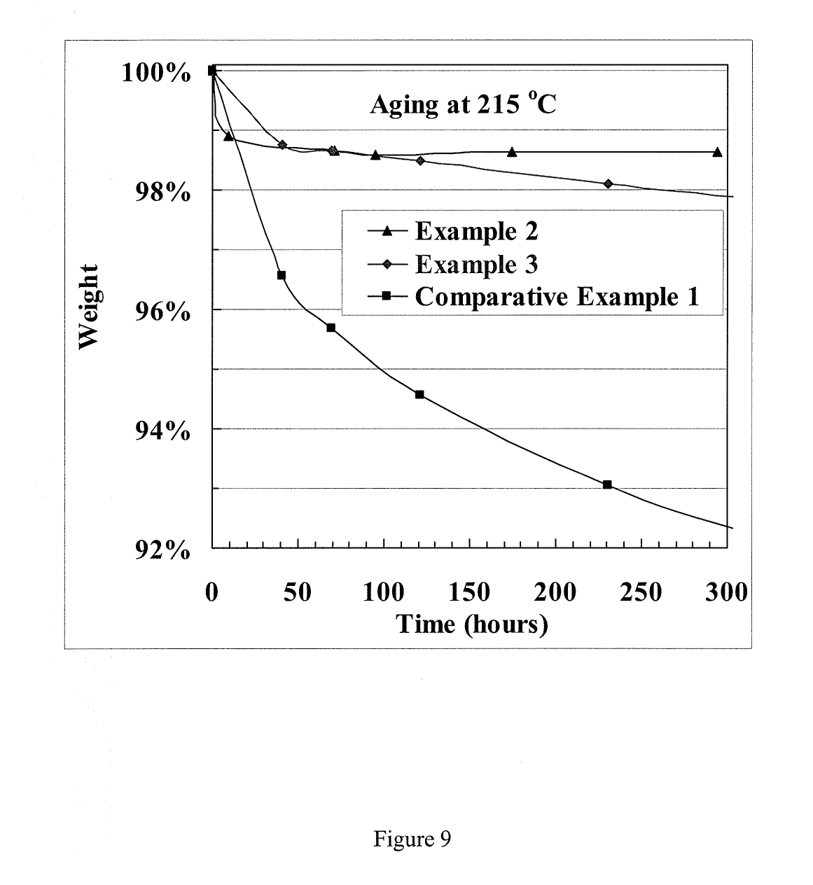

Thermal aging tests were conducted for Examples 2 and 3 with respect to the conventional varnish composition of Comparative Example 1 and are shown in FIGS. 8 and 9. At 195° C. thermal aging (FIG. 8), the Comparative Example 1 UPE varnish lost 5% weight in about 600 hours, whereas the Example 3 PPE varnish exhibited much better thermal stability with less than 2% weight in 1200 hours. At 215° C. thermal aging (FIG. 9), the Example 2 PPE varnish with 0.06 IV exhibits similar thermal stability to the composition of Example 3 and both have much better performance than the Comparative Example 1 UPE varnish.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A composition comprising:
a functional poly(phenylene ether) having an intrinsic viscosity in the range of about 0.06 deciliters per gram to about 0.2 deciliters per gram, measured in chloroform at 25° C.; and
a reactive solvent,
wherein the composition, when cured, has a resistance to thermal cycling sufficient to pass a nut cracking test and has a thermal stability sufficient to exhibit weight loss of less than about 2% after aging for 100 hours at 215° C.

2. The composition of claim 1, wherein the poly(phenylene ether) is bifunctional.

3. The composition of claim 1, wherein the poly(phenylene ether) has at least one aliphatic unsaturated end group.

4. The composition of claim 1, wherein the poly(phenylene ether) has two methacrylate end groups.

5. The composition of claim 1, wherein the reactive solvent is selected from the group consisting of vinyl toluene, styrene, t-butyl styrene, dibromostyrene and combinations thereof.

6. The composition of claim 1, wherein the poly(phenylene ether) has an intrinsic viscosity of about 0.09 dl/g to about 0.12 dl/g.

7. The composition of claim 1, wherein the poly(phenylene ether) has a plurality of structural units of the formula: 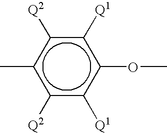
wherein each structural unit may be the same or different, and in each structural unit, each Q₁ is independently halogen, primary or secondary lower alkyl (i.e., alkyl containing up to 7 carbon atoms), phenyl, haloalkyl, aminoalkyl, hydrocarbonoxy, or halohydrocarbonoxy wherein at least two carbon atoms separate the halogen and oxygen atoms, and each Q₂ is independently hydrogen, halogen, primary or secondary lower alkyl, phenyl, haloalkyl, hydrocarbonoxy or halohydrocarbonoxy wherein at least two carbon atoms separate the halogen and oxygen atoms.

8. The composition of claim 7, wherein Q₁ is methyl and Q₂ is hydrogen.

9. The composition of claim 1, wherein the poly(phenylene ether) has formula: 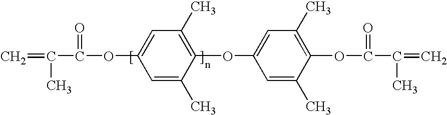
wherein n is any number sufficient to result in an intrinsic viscosity in the range of about 0.06 deciliters per gram to about 0.2 deciliters per gram, measured in chloroform at 25° C.

10. The composition of claim 1 further comprising a curing initiator, a curing inhibitor or a combination thereof.

11. The composition of claim 1 further comprising a cross-linking agent selected from the group consisting of polybutadiene-methacrylate, trimethylolpropane triacrylate, ethoxylated bisphenol A, and combinations thereof.

12. The varnish composition of claim 1 further comprising a cross-linking agent selected from the group consisting of divinylbenzenes, diallylbenzenes, trivinylbenzenes, triallylbenzenes, divinyl phthalates, diallyl phthalates, triallyl mesate, triallyl mesitate, triallyl cyanurate, triallyl isocyanurate, trimethylolpropane tri(meth)acrylate, 1,6-hexanediol di(meth)acrylate, neopentyl glycol di(meth)acrylate, dipropylene glycol di(meth)acrylate, ethylene glycol di(meth)acrylate, propylene glycol di(meth)acrylate, cyclohexanedimethanol di(meth)acrylate, butanediol di(meth)acrylate, diethylene glycol di(meth)acrylate, triethylene glycol di(meth)acrylate, isobornyl(meth)acrylate, methyl (meth)acrylate, methacryloxypropyl trimethoxysilane, bisphenol A dimethacrylate, (ethoxylated)₁₋₂₀ nonylphenol (meth)acrylates, (propoxylated)₁₋₂₀ nonylphenol (meth)acrylates, (ethoxylated)₁₋₂₀ tetrahydrofurfuryl(meth)acrylates, (propoxylated)₁₋₂₀ tetrahydrofurfuryl(meth)acrylates, (ethoxylated)₁₋₂₀ hydroxyethyl(meth)acrylates, (propoxylated)₁₋₂₀ hydroxyethyl(meth)acrylates, (ethoxylated)₂₋₄₀ 1,6-hexanediol di(meth)acrylates, (propoxylated)₂₋₄₀ 1,6-hexanediol di(meth)acrylates, (ethoxylated)₂₋₄₀ 1,4-butanediol di(meth)acrylates, (propoxylated)₂₋₄₀ 1,4-butanediol di(meth)acrylates, (ethoxylated)₂₋₄₀ 1,3-butanediol di(meth)acrylates, (propoxylated)₂₋₄₀ 1,3-butanediol di(meth)acrylates, (ethoxylated)₂₋₄₀ ethylene glycol di(meth)acrylates, (propoxylated)₂₋₄₀ ethylene glycol di(meth)acrylates, (ethoxylated)₂₋₄₀ propylene glycol di(meth)acrylates, (propoxylated)₂₋₄₀ propylene glycol di(meth)acrylates, (ethoxylated)₂₋₄₀ 1,4-cyclohexanedimethanol di(meth)acrylates, (propoxylated)₂₋₄₀ 1,4-cyclohexanedimethanol di(meth)acrylates, (ethoxylated)₂₋₄₀ bisphenol-A di(meth)acrylates, (propoxylated)₂₋₄₀ bisphenol-A di(meth)acrylates, (ethoxylated)₃₋₆₀ glycerol tri(meth)acrylates, (propoxylated)₃₋₆₀ glycerol tri(meth)acrylates, (ethoxylated)₃₋₆₀ trimethylolpropane tri(meth)acrylates, (propoxylated)₃₋₆₀ trimethylolpropane tri(meth)acrylates, (ethoxylated)₃₋₆₀ isocyanurate tri(meth)acrylates, (propoxylated)₃₋₆₀ isocyanurate tri(meth)acrylates, (ethoxylated)₄₋₈₀ pentaerythritol tetra(meth)acrylates, (propoxylated)₄₋₈₀ pentaerythritol tetra(meth)acrylates, (ethoxylated)₆₋₁₂₀ dipentaerythritol tetra(meth)acrylates, (propoxylated)₆₋₁₂₀ dipentaerythritol tetra(meth)acrylates, and mixtures thereof.

13. The composition of claim 1, wherein the ratio of the poly(phenylene ether) to the reactive solvent is in the range of about 2:1 to about 1:5 by weight.

14. The composition of claim 1, wherein the poly(phenylene ether) is at least about 20% soluble in the reactive solvent at room temperature.

15. The composition of claim 1, wherein the poly(phenylene ether) is at least about 40% soluble in the reactive solvent at room temperature.

16. A composition comprising:
a functional poly(phenylene ether) having an intrinsic viscosity in the range of about 0.06 deciliters per gram to about 0.2 deciliters per gram, measured in chloroform at 25° C.; and
a reactive solvent,
wherein the composition, when cured, has a glass transition temperature higher than about 75° C. and an elongation to break greater than about 2%.

17. The composition of claim 16 wherein the thermoset has a glass transition temperature of about 120° C. to about 165° C.

18. The composition of claim 16 wherein the poly(phenylene ether) has an intrinsic viscosity of about 0.09 dl/g to about 0.12 dl/g.

19. The composition of claim 16 wherein the poly(phenylene ether) is bifunctional.

20. The composition of claim 16 wherein the poly(phenylene ether) has at least one aliphatic unsaturated end group.

21. The composition of claim 16 wherein the poly(phenylene ether) has two methacrylate end groups.

22. A composition for electrically insulating a motor comprising:
a bifunctional poly(phenylene ether) having an intrinsic viscosity in the range of about 0.06 deciliters per gram to about 0.2 deciliters per gram, measured in chloroform at 25° C.; and
a reactive solvent,
wherein the composition, when cured, has a resistance to thermal cycling sufficient to pass a nut cracking test and has a thermal stability sufficient to exhibit weight loss of less than about 2% after aging for 100 hours at 215° C.

23. A composition for electrically insulating a motor comprising:
a poly(phenylene ether) having the structural formula 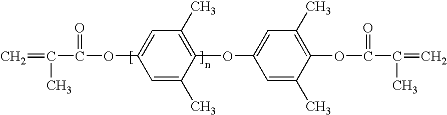
wherein n is any number sufficient to result in an intrinsic viscosity of about 0.09 deciliters per gram, measured in chloroform at 25° C.; and
a reactive solvent selected from the group consisting of vinyl toluene, styrene, t-butyl styrene, dibromostyrene and combinations thereof,
wherein the weight ratio of poly(phenylene ether) to reactive solvent is in the range of about 2:1 to about 1:5 and wherein the composition, when cured, has a resistance to thermal cycling sufficient to pass a nut cracking test and has a thermal stability sufficient to exhibit weight loss of less than about 2% after aging for 1200 hours at 225° C.

24. A composition for electrically insulating a motor comprising:
a poly(phenylene ether) having the structural formula 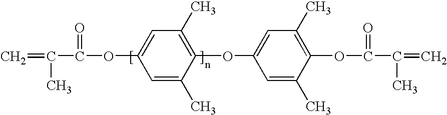
wherein n is any number sufficient to result in an intrinsic viscosity of about 0.06 deciliters per gram, measured in chloroform at 25° C.; and
a cross-linking agent selected from the group consisting of polybutadiene-methacrylate, trimethylolpropane triacrylate, ethoxylated bisphenol A, and combinations thereof, and
a reactive solvent selected from the group consisting of vinyl toluene, styrene, t-butyl styrene, dibromostyrene and combinations thereof
wherein the weight ratio of poly(phenylene ether) to cross-linking agent to reactive solvent is about 3:4:3 and wherein the composition, when cured, has a resistance to thermal cycling sufficient to pass a nut cracking test and has a thermal stability sufficient to exhibit weight loss of less than about 2% after aging for 100 hours at 215° C.

25. A composition for electrically insulating a motor comprising:
a mono functional poly(phenylene ether) having a methacrlylate end group and an intrinsic viscosity of about 0.12 deciliters per gram, measured in chloroform at 25° C.;
a reactive solvent selected from the group consisting of vinyl toluene, styrene, t-butyl styrene, dibromostyrene and combinations thereof, and
a cross-linking agent selected from the group consisting of polybutadiene-methacrylate, trimethylolpropane triacrylate, ethoxylated bisphenol A, and combinations thereof,
wherein the composition, when cured, has a resistance to thermal cycling sufficient to pass a nut cracking test and has a thermal stability sufficient to exhibit weight loss of less than about 2% after aging for 100 hours at 215° C.

26. A method for electrically insulating a motor using a varnish composition comprising
providing a component of a motor;
applying a varnish composition to the motor component, the varnish composition comprising
a functional poly(phenylene ether) having an intrinsic viscosity in the range of about 0.06 deciliters per gram to about 0.2 deciliters per gram, measured in chloroform at 25° C. and
a reactive solvent; and
curing the varnish composition to form an electrically insulative thermoset coating over the motor component, wherein the cured thermoset coating has a resistance to thermal cycling sufficient to pass a nut cracking test and has a thermal stability sufficient to exhibit weight loss of less than about 2% after aging for 100 hours at 215° C.

27. A motor comprising:
a traction motor winding coated with a thermoset resin, wherein the thermoset resin comprises poly(phenylene ether) with at least one aliphatic unsaturated end group having an intrinsic viscosity in the range of about 0.06 deciliters per gram and about 0.2 deciliters per gram, measured in chloroform at 25° C., crosslinked with a reactive solvent, wherein the thermoset resin has a resistance to thermal cycling sufficient to pass a nut cracking test and has a thermal stability sufficient to exhibit weight loss of less than about 2% after aging for 100 hours at 215° C.

28. The motor of claim 27 wherein the traction motor is a locomotive traction motor.

29. The motor of claim 27 wherein the traction motor is an off highway vehicle traction motor.
